(19) United States
(12) Patent Application Publication
(10) Pub. No.: US 2005/0259675 A1
(43) Pub. Date: Nov. 24, 2005

(54) Method of communication

(75) Inventors: Markku Tuohino, Espoo (FI); Miikka Poikselka, Espoo (FI); Georg Mayer, Helsinki (FI); Ilkka Westman, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/932,253

(22) Filed: Sep. 2, 2004

(30) Foreign Application Priority Data
Apr. 6, 2004 (GB) 0407823.4

(51) Int. Cl. H04L 12/66

(52) U.S. Cl. 370/426

(57) ABSTRACT

A method of communication includes sending a message from first user equipment to set up communication. The method also includes receiving information at a server relating to a status of second user equipment. The method also includes generating a message at the server in response to the information. The method also includes sending the message to the first user equipment.

### BACKGROUND OF THE INVENTION

1. Field of the Invention

The present invention relates to a method of communication and in particular but not exclusively to a method of communication for use in a push-to-talk system.

2. Description of the Related Art

A communication system can be seen as a facility that enables communication sessions between two or more entities such as user equipment and/or other nodes associated with the communication system. The communication may comprise, for example, communication of voice, data, multimedia and the like. A session may, for example, be a telephone call type session between users, a multi-way conference session, or a communication session between user equipment and an application server (AS) such as a service provider server.

A communication system typically operates in accordance with a given standard or specification which sets out what the various entities associated with the communication system are permitted to do and how that should be achieved. For example, the standard or specification may define if the user, or more precisely, user equipment is provided with a circuit switched service and/or a packet switched service. Communication protocols and/or parameters which shall be used for the connection may also be defined. In other words, a specific set of rules on which the communication can be based is defined to enable communication.

Communication systems providing wireless communication for user equipment is known. An example of a wireless system is the public land mobile network (PLMN). PLMNs are commonly based on cellular technology. In cellular systems, a base transceiver station (BTS) or similar access entity services mobile user equipment (UE) via a wireless interface between these entities. The communication on the wireless interface between the user equipment and elements of the communication network can be based on an appropriate communication protocol. The operation of the base station apparatus and other apparatus required for the communication can be controlled by one or several control entities. The various control entities may be interconnected.

One or more gateway nodes may be provided for connecting the cellular access network to other networks, for example to a public switched telephone network (PSTN) and/or other communication networks such as an IP (Internet Protocol) and/or other packet switched data networks. In such arrangements, the mobile communications network provides an access network enabling a user with wireless user equipment to access external networks, hosts, or services offered by specific service providers.

An example of the type of services that may be offered to a user such as a subscriber to a communication system is the so called multimedia service. Some of the communication systems enabled to offer multimedia services are known as internet protocol multimedia networks. IP multimedia functionalities can be provided by means of an IP multimedia core network subsystem (IMS). The IMS includes various network entities for the provision of multimedia services. IMS services are intended to offer, amongst other services, IP based packet data communication sessions between mobile user equipment.

In a packet data network, a packet data carrier may be established to carry traffic flows over the network. An example of such a packet data carrier is a packet data protocol (PDP) context.

Various types of services are provided by means of different application servers (AS) over IMS. Some of these services may be time critical. An example of a time critical service that may be provided over the IMS is the so-called direct voice communication service. One example of this type of service is the “push-to-talk over cellular” (PoC) service also known as the PTT (push-to-talk service). The direct voice communication services are intended to use the capabilities of the IMS to enable IP connections for user equipment and other parties to the communication, such as other user equipment or entities associated with the network. The service allows users to engage in immediate communication with one or more users.

In PoC services, communication between user equipment and a PoC application server commonly occurs on a one-way data communications media. A user may open the data communications media by simply pushing a key, for example a button on the key board or key pad of the user equipment or by otherwise activating the communications media. The activation may be via a specific button, tangent or any other appropriate key of the key board. Similar principals apply with devices having touch sensitive or sound activated user interfaces. While the user speaks, the other user or users may listen. Bi-directional communication may be offered since all parties of the communication session may similarly communicate voice data with the PoC application server. Turns to speak are requested by activating the push to talk button or the like. The turns may be granted on a first come first served basis or based on priorities.

The nature of PoC communication is instant and typically connection between users is established extremely fast, for example, within a couple of seconds. However, in the PoC system environment, a user is able to configure the terminal to either answer automatically the in coming PoC communication request or be prompted before the terminal answers the request. In the latter case, the user will receive some signal that an incoming PoC communication request is received. The user interacts with the user equipment to send a suitable response. However, this latter option can cause problems. In the first mentioned case the originator of a PoC communication is able to start speaking in a couple of seconds. This is not the case where the originating caller has to wait until the other party manually accepts the PoC communication. This may take a relatively long period before the destination party answers. The originating party is not aware of the status of the PoC communication and hence does not get any indication as to whether or not the request has been received by the destination party. Thus, end users can not see any reason why the communication set up is taking so long. This may lead the calling party to assume that there is some network problem.

In the session initiation protocol (SIP) as developed by the internet engineering task force (IETF), there is a message “180 ringing”. This is used, for example, to indicate that the destination user has been alerted and that an answer is expected any time now. When the calling party uses the REFER method to invite the destination user to a session, there is no control plane action for the PoC server to advise the calling party that the session set up is in ringing state i.e. the manual answer mode. When the 180 ringing message is received, the PoC server may generate a floor control message to indicate permission to start speaking. The message could be an RTCP (real-time transport protocol control protocol) floor granted message. However, this message is on the user plane. The user plane is used for user data communication. This is at odds with standards such as 3GPP and OMA (Open Mobile Alliance) as the mixture of control plane signalling and the user plane data is undesirable.

### SUMMARY OF THE INVENTION

Embodiments of the present invention aim to address the above described problems.

According to a first aspect of the present invention, there is provided a method communication, said method comprising the steps of: sending a message from first user equipment to set up communication; receiving information at a server relating to a status of second user equipment;
generating a message at said server in response to said information; and sending said message to first user equipment.

According to another aspect of the present invention, there is provided a communication system comprising first user equipment, second user equipment and a server, said first user equipment comprising means for sending a message from first user equipment to set up communication and said server comprises means for receiving information relating to a status of second user equipment, means for generating a message in response to said information, and means for sending said message to first user equipment.

According to another aspect of the present invention, there is provided a server for use in a communication system, said server comprising means for receiving information relating to a status of second user equipment, means for generating a message in response to said information, and means for sending said message to first user equipment.

According to another aspect of the present invention, there is provided user equipment for use in a communications system, said user equipment comprising: means for sending a message from said user equipment to set up communication with second user equipment; means for receiving a message at said user equipment, said message including information relating to the status of said second user equipment.

### BRIEF DESCRIPTION OF DRAWINGS

For a better understanding of the present invention reference will now be made by way of example only to the accompanying drawings in which:

FIG. 1 shows a communication system in which embodiments of the present invention may be incorporated; and

FIG. 2 is a signalling flow chart illustrating the signalling in one embodiment of the present invention.

### DETAILED DESCRIPTION OF THE PREFERRED EMBODIMENTS

Certain embodiments of the present invention will be described by way of example, with reference to the exemplifying architecture of a third generation (3G mobile communication system). However it will be understood that embodiments may be applied to any other suitable forms of communication system.

The third generation partnership project (3GPP) has defined a reference architecture for the third generation (3G) core network which will provide the users of user equipment with access to multimedia services. This core network is divided into three principal domains. These are the circuit switched (CS) domain, the packet switched (PS) domain and the internet protocol multimedia subsystem (IMS) domain.

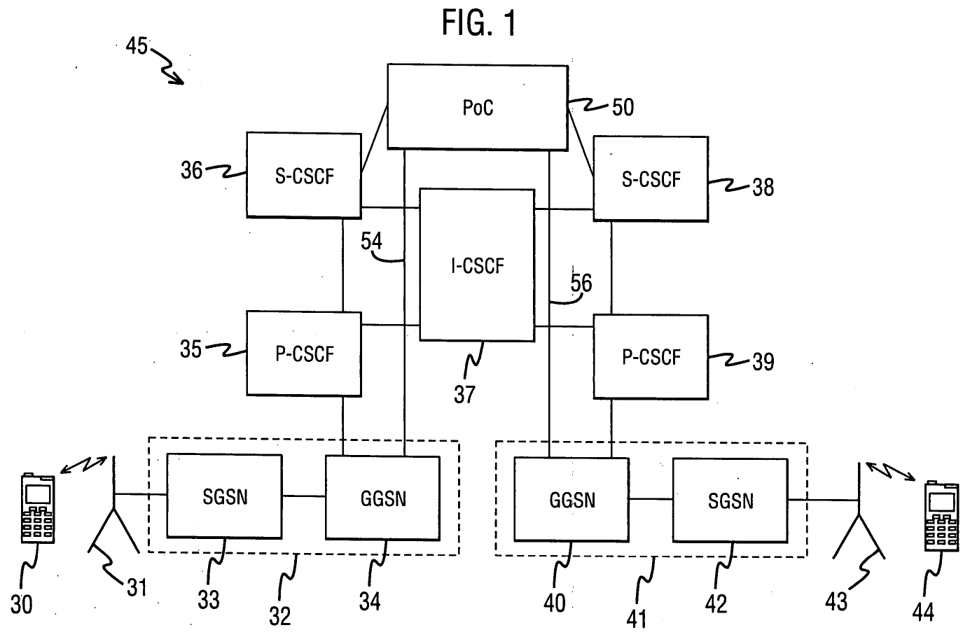

FIG. 1 shows an IP multimedia network 45 for offering IP multimedia services to IP multimedia network subscribers. IP multimedia subsystem (IMS) functionalities may be provided by a core network (CN) subsystem including various entities for the provision of the service. The third generation partnership project (3GPP) has defined the use of the general packet radio service (GPRS) for offering IP connectivity to IMS services. Accordingly, a GPRS based system will be used in the following example of a possible back bone communication network enabling the IMS services.

A mobile communication system such as the 3G cellular system is typically arranged to serve a plurality of mobile user equipment, usually via a wireless interface between the user equipment and base stations of the communication system. The mobile communication system may logically be divided between a radio access network (RAN) and a core network (CN). The core network entities typically include various control entities and gateways for enabling the communication via a number of radio access networks and also for interfacing a single communication system with one or more communication systems such as with other cellular systems and/or fixed line communications systems.

In FIG. 1, the intermediate mobile communication network provides packet switched data transmission in the packet switched domain between a support node and mobile user equipment. Different sub networks are in turn connected to an external data network, for example to a packet switched data network (PSPDN) via gateway GPRS support nodes (GGSN) 34, 40. The GPRS services thus allow transmission of packet data between mobile data terminals and/or external data networks. More particularly, the exemplifying general packet radio services operation environment comprising one or more sub network service areas, which are interconnected by GPRS back bone networks 32 and 41. A sub network comprises a number of packet data service nodes (SN). In this embodiment, the service nodes will be referred to as serving GPRS support nodes (SGSN). Each of the SGSNs 33, 42 is connected to at least one mobile communication network, typically to base station systems. Although not shown for clarity reasons, the connection may be provided by way of radio network controllers or other access system controllers such as base station controllers in such a way that packet service can be provided for mobile user equipment via several base stations.

Base stations 31 and 43 are arranged to transmit signals to and receive signals from mobile user equipment 30 and 44 of mobile users i.e. subscribers, via respective wireless interfaces. Correspondingly, each of the mobile user equipment is able to transmit signals to and receive signals from the base stations via the wireless interface. In the simplified representation of FIG. 1, the base stations 31 and 43 belong to respective radio access networks (RAN). In the arrangement shown, each of the user equipment 30 and 44 may access the IMS network 45 via the two access networks associated with the base stations 31 and 43 respectively. It should be appreciated that, although FIG. 1 only shows the base stations of two radio access networks, a typical mobile communication network usually includes a number of radio access networks.

The IMS domain is for ensuring that multimedia services are adequately managed. The IMS domain commonly supports the session initiation protocol (SIP) as developed by the internet engineering task force (IETF). Session initiation protocol (SIP) is an application-layer control protocol for creating, modifying and terminating sessions with one or more participants (end point). SIP was generally developed to allow for the initiation of a session between two or more end points in the Internet by making these end points aware of the session semantics. A user connected to an SIP base communication system may communicate with various entities of the communication system based on standardised SIP messages. User equipment or users that run certain applications on the user equipment are registered with the SIP backbone so that an invitation to a particular session can be correctly delivered to these end points. SIP provides a registration mechanism for devices and users and it applies mechanisms such as location servers and registrars to route the session invitations appropriately. Examples of proper possible sessions that may be provided by SIP signalling include internet multimedia conferences, internet telephone calls and multimedia distribution.

User equipment within the radio access network may communicate with a radio network controller via radio network channels which are typically referred to as radio bearers. Each user equipment may have one or more radio channels open at any one time with the radio network controller. Any appropriate mobile user equipment adapted for internet protocol (IP) communication maybe used to connect to the network. For example, a user may access the cellular network by means of user equipment such as a personal computer, personal data assistant (PDA), mobile station (MS), portable computer, combinations thereof or the like. Embodiments of the present invention are described in the context of mobile stations.

A mobile station is used for tasks such as making and receiving phone calls, for receiving and sending data from and to a network and for experiencing for example multimedia content. A mobile station is typically provided with a processor and memory for accomplishing these tasks. A mobile station may include an antenna for wirelessly receiving and transmitting signals from and to base stations of the mobile communication network. A mobile station may also be provided with a display for displaying images and other graphical information for the user of the mobile user equipment. A speaker may also be provided. The operation of the mobile station may be controlled by means of a suitable user interface such as key pad, voice commands, touch sensitive screen or pad, combinations thereof or the like.

The mobile stations 30 and 44 of FIG. 1 are configured to enable the use of push to talk types of services. An activation function that may be required by a push to talk service can be provided by one of the buttons on the keypad of the mobile station 30 and 44 or by a specific key or button such as the type known from—“walkie-talkie” devices.

It should be appreciated that FIG. 1 only shows two mobile stations for clarity. In practice, a number of mobile stations may be in simultaneous communication with each base station. A mobile station may have several simultaneous sessions, for example a number of SIP sessions and activated PDP contexts. For example, the user may have a phone call and be simultaneously connected to at least one other service.

Overall communication between user equipment in an access entity and the GGSN is provided by a PDP context. Each PDP context provides a communication pathway between a particular user and a GGSN. Once the PDP context is established, it can typically carry multiple flows. Each flow normally represents, for example, a particular service and/or media component of a particular service. The PDP context therefore often represents a logical communication pathway for one or more flows across the network. To implement the PDP context between user equipment and the serving GPRS support node, radio access bearers need to be established which commonly allow for data transfer for the user equipment.

Communication systems have developed such that services may be provided for user equipment by means of various functions of the IM network 45 that are handled by network entities and served by the servers. In the current 3G wireless multimedia network architectures, it is assumed that several different servers are for handling different functions. These include functions such as the call session control functions (CSCF). The call session control functions can be divided into various categories such as a proxy call session control function (P-CSCF) 35, 39, interrogating call session control function (I-CSCF) 37 and serving call session control function (S-CSCF) 36, 38.

The user equipment 30, 44 may connect via the GPRS network to application servers that are generally connected to the IMS. In FIG. 1, such an application server is provided by a push-to-talk-over cellular (PoC) services server 50. In one modification there may be another PoC server for the called party. Thus, it should be appreciated that the PoC server connected to S-CSCF 38 may not be the same as the PoC server connected to the S-CSCF 36.

The mobile user equipment 30 and 44 can be from different IMS networks.

The PoC application server is for providing push-to-talk over cellular (PoC) services over the IMS network 45. The push-to-talk service is an example of the so called direct voice communication service. Users who wish to use the PoC service may need to subscribe to an appropriate PoC server.

The direct voice communication services are intended to use the capabilities of the GPRS back bone and the control functions of the multimedia subsystem for enabling IP connections with the mobile stations 30 and 44. The PoC server may be operated by the operator of the IMS system or a third party service provider.

A user may open the communication link, for example, by pressing a specific activation button on the mobile station 30. While the user of the mobile station 30 speaks, the user of the mobile station 44 listens. The user of the mobile station 44 may then reply in a similar manner. The signalling between the user equipment and the appropriate call session control functions is routed via the GPRS network. The user plane session sets up signalling for the user equipment and is routed via and controlled by the PoC application server 50. In other words, the PoC application server 50 can control both the control plane (for signalling) and the User plane (for user data) of the PoC user. The control plane traffic between the PoC application server and the user equipment may be routed via the IMS 45 whilst the user plane traffic between the user equipment and the PoC server may be routed from the GPRS system to the PoC application server on interfaces 54 and 56.

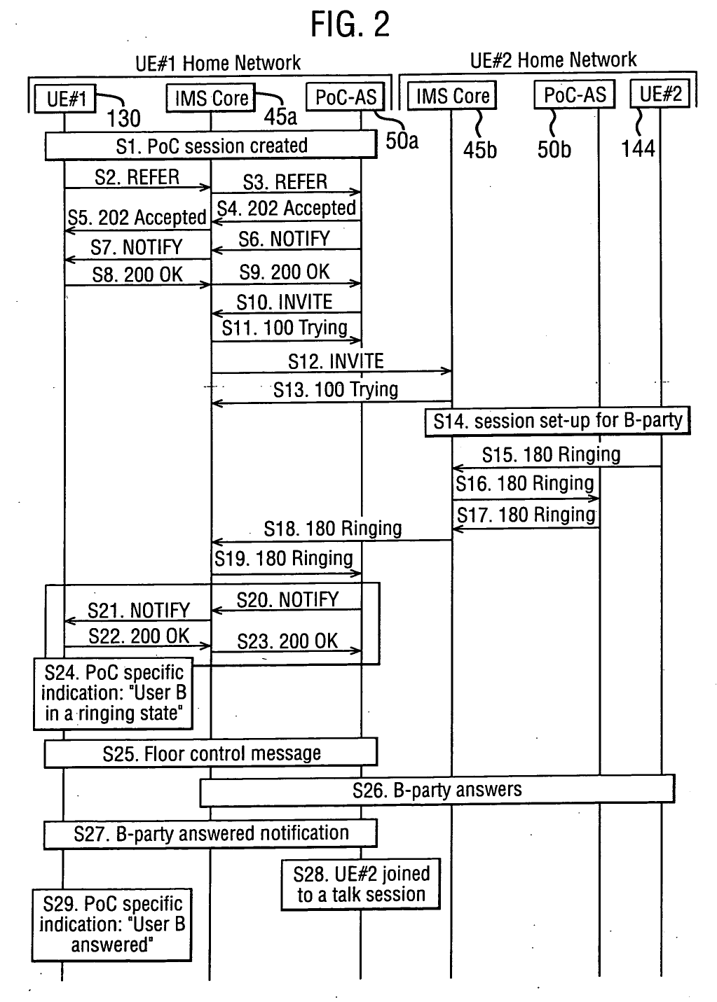

Reference will now be made to FIG. 2 which shows a signalling flow in an embodiment of the present invention. In the embodiment shown in FIG. 2, a first user equipment 130 wishes to make a connection with user equipment 144. In this embodiment, the user equipment comprises PoC clients. The first user 130 is in one network and the other user 144 is in a different network. It should be appreciated that in some embodiments of the present invention, the users may be in the same network and the signalling may be simplified accordingly. The home network of the user equipment 130 comprises an IMS or a SIP/IP core 45a and PoC application server 50a. The home network of the second user 144 comprises an IMS or SIP/IP core 45b and a PoC application server 50b. Where the user equipment 130 and 144 are in the same network, the application service 50a and 50b may be provided by a common entity. Likewise, the cores 45a and 45b may also be provided by a common entity.

In step S1, the PoC session is created between the user equipment 130, the IMS core 45a and the PoC application server 50a. This is initiated by the user activating an appropriate button or the like on the user equipment.

In step S2, a REFER message is sent from the first user equipment 130 to its associated IMS core 45a. The REFER message is defined for example in the IETF specification RFC 3515. The REFER message indicates that the recipient (identified by the request-URI) should contact a third party using the contact information provided in the request. In embodiments of the present invention, the recipient would be the PoC AS 50a and the third party would be the second user equipment 144. There is the so-called Pre-established session between the user equipment 130 and the PoC server 50a and the recipient is the PoC session URI hosted in the PoC server 50a.

In step S3, the REFER message is forwarded from the IMS core 45a to the PoC application server 50a.

In step S4, the PoC application server 50a sends an acknowledgement message in a form of a 202 Accepted message. This acknowledgement is forwarded in step S5 from the IMS core 45a to the user equipment 130.

In step S6, a NOTIFY message is sent from the application server to the IMS core 45a. The PoC server 50a sends the NOTIFY request to advise about the REFER request processing. The body of the NOTIFY request contains a fragment of the response as received by the notifying PoC server for the request that was initiated due to REFER request.

In step S7, the NOTIFY message is forwarded by the IMS core, 45a to the user equipment 130.

In step S8, a 200 OK acknowledgement is sent from the user equipment 130 to the IMS core 45a. In step S9, the 200 OK message is forwarded by the IMS core 45a to the PoC application server 50a.

In step S10, the PoC application server 50a sends an INVITE message to the IMS call 45a. This is for requesting a connection with the second user equipment 144.

In step S11, the IMS core 45a sends a 100 Trying message to the PoC application server 50a indicating that it is trying to establish the connection.

In step S12 the IMS core 45a sends an INVITE message to the IMS core 45b of the second user equipment 144. This INVITE message is in order to establish a connection with the second user equipment 144.

The IMS core 45b replies with a message in step S13 100 Trying indicating that it is attempting to establish a connection.

In step S14, a session is set up between the IMS core 45b, the PoC application server 50b and the user equipment 144.

As the user equipment 144 is in the mode where the user is prompted before the terminal answers the request, the user equipment 144 sends in step S15 a 180 Ringing message. This is sent to the IMS core 45b.

In step S16, the 180 ringing message is sent from the IMS core 45b to the PoC application server 50b. This message is then sent back, in step S17, to the IMS core 45b from the PoC application server 50b. The IMS core 45b associated with the second user equipment 144 then forwards the 180 Ringing message in step S18 to the IMS core 45a associated with the first user equipment. It should be appreciated that step S16 and S17 are required in order that the destination for the 180 ringing message in the caller's home network be established.

In step S19, the 180 ringing message is sent from the IMS core 45a to the PoC application server 50a of the first user equipment's home network.

Alternatively, the PoC application server 50b may perform step S17 prior to contacting the user equipment 144 as it knows that the user of the user equipment 144 is using manual answer mode.

Yet another alternative is that the PoC application server 50b may respond with another suitable provisional response (e.g. 183 Session Progress) before sending the session set-up to the invited party (step S14).

In step S20 the PoC application server 50a prepares a NOTIFY message which is sent to the IMS core 45a. This is to indicate the ringing state to the calling party, that is the first user equipment.

In step S21, the NOTIFY message is forwarded by the IMS core 45a to the user equipment 130.

In step S22, the user equipment 130 sends the acknowledgement 200 OK to the IMS core 45a. This acknowledgement is forwarded in step S23 to the PoC application server 50a.

In step S24, the first user equipment 130 generates, in response to the NOTIFY message, a visual or audible message to the user indicating the session state change, that is of the ringing state. It may also indicate if it is possible to send or not a talk burst.

In step S25, a floor control information may be exchanged on the user plane between the PoC server 50a and the user equipment 130.

In step S26, the second user 144 answers. This information is made available to the PoC application servers 50a and 50b and the IMS cores 45a and 45b.

In step S27, the PoC server advises first user equipment 130, that the destination user has answered.

A floor control message Floor Granted may be sent on the user plane from the PoC server 50a to the user equipment 130.

In step S28, the second user equipment is joined to the talk session.

In step S29, a PoC specific indication is displayed or indicated to the user equipment 130 indicating that destination user has answered.

In the case of a multiple invitation with REFER or other means, the PoC generates the NOTIFY message of ringing state when it receives the first 180 ringing response. It may generate additional notifying messages when more 180 ringing response are received from other users.

Depending on network policy the routing of INVITE messages in step S10 may differ. It is possible that in step S10 the INVITE message is sent directly to the home network of the User equipment 144. The S10 message may therefore be sent directly to the SIP/IP core 45b or to the PoC application server 50b. Correspondingly, the responses to the INVITE message follows the established signalling path.

The method embodying the invention can initiate a floor control from the user equipment when the notification about the session progress is received.

It should be appreciated that embodiments of the present invention are described in the context of REFER based session invitations. Embodiments of the present invention may be equally applicable to other types of message.

It should be appreciated that embodiments of the present invention have been described in the context of floor control messages. It should be appreciated that there may be other types of message which are also applicable in embodiments of the present invention.

The embodiment of the invention has been described in the context of an IMS system and GPRS network. However, this invention is also applicable to any other access techniques. Furthermore, the given examples are described in the context of SIP networks with SIP capable entities. This invention is also applicable to any other appropriate communication systems, whether wireless or fixed line systems.

The embodiments of the invention have been described in the context of 3GPP systems but embodiments of the invention are also applicable to 3GPP2 systems. In 3GPP2, the IP multimedia is called MMD (Multi-Media Domain). The 3GPP2 MMD is IMS and PDS, (PDS=Packet Data Subsystem). In 3GPP2 the terminology regarding the packet data network is different, for example, the term “GPRS” is not used but IP Connectivity Network is referred to, which refers to any collection of network entities and interfaces that provides the underlying IP transport connectivity to or between IMS entities. Also, instead of the PDP context, for example, the term IP-Connectivity Network Bearer is used. Accordingly terminology used in the appended claims and description should be construed to cover entities and systems providing similar functions but named using different terminology.

It should be appreciated that whilst embodiments of the present invention have been described in relation to mobile stations, embodiments of the present invention are applicable to any other suitable type of user equipment.

Embodiments of the present invention have been described in the context of push-to-talk communication. However embodiments of the invention can be used in any other appropriate context such as for example conferencing.

It should be appreciated that the actual signal flow used may differ in different embodiments of the present invention and different types of messaging may be used to achieve a similar effect.

It is also noted herein that whilst the above describes exemplifying embodiments of the invention, there are several variations and modifications which may be made to the disclosed solution without departing from the scope of the invention as defined in the depended claims.

1. A method of communication, said method comprising the steps of:
sending a first message from first user equipment to set up communication;
receiving information at a server relating to a status of second user equipment;
generating a second message at said server in response to said information; and
sending said second message to said first user equipment.

2. A method as claimed in claim 1, wherein said first user equipment comprises calling user equipment.

3. A method as claimed in claim 1, wherein said generating said second message step comprises generating a notification message comprising the information relating to the status of the second user equipment.

4. A method as claimed in claim 1, further comprising sending said first and second messages in accordance with session initiation protocol.

5. A method as claimed in claim 3, wherein said generating said second message step comprises generating a NOTIFY message.

6. A method as claimed in claim 1, comprising the step of providing said information to a user about the status of the second user equipment, in response to the second message sent to the first user equipment.

7. A method as claimed in claim 6, wherein the providing said information step comprises displaying said information.

8. A method as claimed in claim 1, comprising the step of generating a request and sending said request to said server in response to said first message by said first user equipment.

9. A method as claimed in claim 8, wherein said generating said request step comprises generating said request for a user of said first user equipment for permission to talk.

10. A method as claimed in claim 8, wherein the generating and sending said request step comprises generating and sending said request on a user plane.

11. A method as claimed in claim 1, wherein said second user equipment comprises a destination user equipment.

12. A method as claimed in claim 1, wherein said information comprises information indicating that said second user equipment is ringing.

13. A method as claimed in claim 4, wherein said information comprises a 180 ringing message.

14. A method as claimed in claim 1, wherein said sending step comprises sending said first message from said first user equipment to set up said communication, wherein said communication comprises a push-to-talk communication.

15. A method as claimed in claim 14, wherein said push-to-talk communication comprises a push-to-talk communication over cellular.

16. A method as claimed in claim 14, comprising the step of sending a floor control request to the server from the first user equipment.

17. A method as claimed in claim 16, wherein said step of sending said floor control request is carried out when said first user equipment receives information that said second user equipment is ringing.

18. A method as claimed in claim 16, further comprising sending said floor control request on the user plane.

19. A method as claimed in claim 16, wherein said floor control request comprises a request for the first user equipment to ask for permission to talk.

20. A method as claimed in claim 14, comprising the step of providing a floor granted message from the server to said first user equipment to provide an indication that said first user equipment is able to send media to said server.

21. A communication system comprising:
first user equipment;
second user equipment; and
a server,
wherein said first user equipment comprises means for sending a first message from said first user equipment to set up communication and
wherein said server comprises means for receiving information relating to a status of said second user equipment, means for generating a second message in response to said information, and means for sending said second message to said first user equipment.

22. A server for use in a communication system, said server comprising:
means for receiving information relating to a status of second user equipment;
means for generating a message in response to said information, and
means for sending said message to a first user equipment.

23. User equipment for use in a communications system, said user equipment comprising:
means for sending a message from said user equipment to set up communication with another user equipment; and
means for receiving a message at said user equipment, said message including information relating to the status of said another user equipment.
